(19) United States
(12) Patent Application Publication
(10) Pub. No.: US 2022/0253780 A1
(43) Pub. Date: Aug. 11, 2022

(54) ANALYTICAL TOOL FOR COLLABORATIVE COMPETITIVE PURSUIT ANALYSIS AND CREATION OF ENTERPRISE VALUE

(71) Applicant: Solutioneering, LLC, Leesburg, VA (US)

(72) Inventors: Peter Lierni, Leesburg, VA (US); Srisurang Setapayak, Reston, VA (US)

(73) Assignee: Solutioneering, LLC, Leesburg, VA (US)

(21) Appl. No.: 17/456,176

(22) Filed: Nov. 23, 2021

Related U.S. Application Data
(60) Provisional application No. 63/200,039, filed on Feb. 11, 2021.

(51) Int. Cl. G06Q 10/06

(52) U.S. Cl. CPC G06Q 10/06375

(57) ABSTRACT

A collaborative analytical pursuit system includes a data repository and server with memory and processor. The system includes opportunity assessment, capture, and proposal planning modules. The processor collects and assesses data on issues and decision factors associated with a bid and competitiveness, identifies discriminators; identifies partners, a leadership team, staffing solution, facilities, tools, certifications, and techniques; develops bid technical and management approaches and a pricing strategy; calculates and stores a value associated with the data; and produces a report including a temporal graph of the value. The data repository stores a data lake of competitive intelligence, intellectual capital, and proprietary data. The system runs a method identifying a customer's vision, mission, and evaluation factors; collecting data on individuals and enterprises; assessing their relationship status; identifying competitiveness gaps; developing a win strategy; automatically generating proposal strategy lists and strengths lists; preparing value statements from a structured template; and producing the report.

### CROSS-REFERENCE TO RELATED APPLICATION

This application claims the benefit of priority of U.S. provisional application No. 63/200,039, filed Feb. 11, 2021, the contents of which are herein incorporated by reference.

### BACKGROUND OF THE INVENTION

The present invention relates to collaborative analysis for competitive pursuits and creation of enterprise value and, more particularly, to an analytical tool therefor.

Often, competitive proposals (e.g., business-to-government, business-to-business, academia-to-government) are submitted without the application of a framework and supporting considerations, practices, and tools to support the design and development of the solution for the proposal in advance of proposal preparation. In particular, the business is often unable to answer the most important question when pursuing a competitive opportunity, “Why your enterprise?” An entity's business pursuit team may rely on personnel with specialized experience to meet this need, but collaboration is essential and is difficult to do when working remotely. The hybrid workplace is here to stay and enterprises that embrace its opportunities will be poised to find the most value.

Existing proposal methods and products fall far short of optimizing competitive business pursuit. Existing products do not optimize, automate, and align the thinking from the Capture Management efforts from across the entire enterprise, capturing the pursuit's necessary up-front evidence-based thinking and facts, to increase the Probability of Winning and the enterprise's overall value, particularly in the view of the marketspace. They do not federate capture management and pre-proposal planning efforts in a traceable, irrefutable, defensible, and explainable manner to show what the enterprise is getting out of its capture efforts regarding time and money spent (i.e., quantifying the quality and effectiveness of business development efforts). None of the existing products provides a method wherein one analysis enables the performance of another, aiding enterprise-wide executives, business developers, capture managers, proposal managers, project managers, technical staff, and other staff who are important to winning business, and supporting design and development of a solution for the proposal. Existing products do not allow for permission-based access to collaborative competitive pursuit analysis activities and their resulting outputs (e.g., proposal strategies) based upon assigned role (e.g., technical contributor, pricing analyst). In addition, existing products do not provide a mobile device-accessible software-as-a-service-based, internal enterprise network-based, or private cloud-based capture-as-a-service capability.

The Solution Engineering Framework™ was designed to help answer the question, “Why your enterprise?”, and is highlighted in Appendix B of Lierni, Solution Engineering, 2019, referenced under ISBN-10:173377940X and ISBN-13:978-1733779401. Solution Engineering is incorporated by reference herein in its entirety. The Framework is limited, however, in that it lacks quantitative indices which collectively measure the quality of performance throughout the business development lifecycle, as well as the overall growth status of the enterprise. The Solution Engineering Framework™ does not provide the likely and actual cost-of-capture of a competitive pursuit. It lacks automated workflows and automatic generation of analysis-based lists of proposal strategies and strengths with which proposal evaluators may base an award decision. The framework lacks embedded training available in text, audio-only, and video formats and the application of Artificial Intelligence/Machine Learning capabilities to assist with competitive pursuit analysis activities and design and development of the strategies and solutions of the proposal. The Solution Engineering Framework™ lacks the ability to measure the overall value of the enterprise when looking at its ability to win future competitive bids and the goodness of the enterprise's intellectual capital in the view of customer evaluators as part of the enterprise's past competitive bids whether the enterprise won or lost the opportunity. It lacks the ability to automatically tailor headings depending on whether the pursuit is business-to-government or business-to-business. In addition, the framework lacks the ability to outline and automatically generate customer-focused stories using Freytag's Pyramid, which is a paradigm of dramatic structure outlining seven key steps in successful storytelling: exposition, inciting incident, rising action, climax, falling action, resolution, and denouement.

As can be seen, there is a need for an automated analytical tool that provides a modular, sequential framework for competitive business pursuits that federates data in a traceable, irrefutable, defensible, and explainable manner, provides indices that measure the quality of business development lifecycle performance, determines enterprise growth status, provides a cost of capturing business, and provides an index that measures overall enterprise value to support market valuation of the enterprise.

### SUMMARY OF THE INVENTION

The present invention provides a collaborative analytical pursuit tool that automates the Solution Engineering Framework™ and provides several additional features. The inventive collaborative analytical pursuit tool is also referred to herein as the Solution Engineering Tool (SET). SET helps enterprises pursuing competitive opportunities to do the necessary “thinking before writing” in the opportunity assessment, capture, and proposal planning phases of their competitive pursuits. This is how winning proposals are engineered, not just written.

SET reduces uncertainty and increases enterprise-wide value over time for competitive pursuits during all phases of the business development lifecycle. This is a smarter way to win more competitive pursuits. SET automatically captures an enterprise's organically derived competitive intelligence and intellectual capital with each pursuit to which it is applied.

SET complements any existing business development process or tool that an enterprise uses. It enables an enterprise to get real-time quantitative insight into the progress of its competitive pursuits, as well as the overall growth status of the enterprise as it pertains to the quality of business development, capture management, and readiness to competitively re-win business. SET measures the growth status of future opportunities across the entire enterprise. SET may quantify the growth status of the enterprise to support valuation of a company with market analysts. SET helps companies increase their valuation in the eyes of other companies interested in acquiring them. SET provides a better gauge on an enterprise's forecasts than the commonly used measure of Probability of Winning (P-Win) because it is based on enabling the critical thinking essential to winning competitive pursuits; providing supporting evidence; and instilling the transparency and accountability often missing in competitive business development efforts.

The inventive tool is well suited for business and solution developers to work face-to-face or remotely when collaboration is essential. It provides capture-as-a-service. The inventive tool It is an on-demand software tool available today for the “future-of-work”, for business and solution developers alike.

SET is an easy-to-use online Tool-of-Tools that orchestrates critical thinking to solve the many problems typical with any competitive pursuit (e.g., business-to-government, business-to-business, academia-to-government). The inventive tool may be offered as a software-as-a-service (SaaS) that enables capture-as-a-service (CaaS), be resident on an enterprise's own internal enterprise network, or accessible via the enterprise's own private cloud such that it is a SaaS enabling CaaS. Each aforementioned offering of the tool is preferably accessible via a mobile device. SET helps optimize and align the thinking from Capture Management efforts from across the entire enterprise to help increase the Probability of Winning. SET stores rich context of how and why a deal was pursued and enables iterative refinement of customer understanding. It may collect and analyze input from team members and store relevant documents. SET instills true accountability into the enterprise's business development lifecycle supporting the trust executive decision-makers need to win by enabling evidence-based decision-making.

SET mitigates the risk associated with disruptions and interruptions that often occur in competitive pursuits by maintaining a traceable, irrefutable, defensible, and explainable digital thread of all pursuit activities and enterprise-wide (e.g., company), competitor, and customer context gathered to date. As such, SET acts as the authoritative source-of-truth for the pursuit and provides continuity through all disruptions and interruptions to the pursuit. In addition, SET measures the quality of business development lifecycle performance, determines enterprise growth status, provides a cost of capturing business, and provides an index that measures overall enterprise value to support market valuation of the enterprise.

In one aspect of the present invention, a collaborative analytical pursuit system for competitive bids is provided comprising: a data repository, embodied in a computer-readable storage medium, configured to store a data lake comprising competitive intelligence data, intellectual capital data, and proprietary data; and a server comprising a memory and a processor, the processor of the server configured to: collect and assess data indicating issues and decision factors associated with a bid in an opportunity assessment module; collect and assess data indicating competitiveness, identifying discriminators, and identifying gaps in bid win themes and bid win tactics in a capture module; identify at least one of: partners, a leadership team, a staffing solution, facilities, tools, certifications, and techniques; and develop a bid technical approach, a bid management approach, and a bid pricing strategy in a proposal planning module; calculate a numerical value associated with data from at least one of the opportunity assessment module; the capture module; and the proposal planning module; store the data and the numerical value in the data repository; and produce a report including a temporal graphical depiction of the numerical value.

In another aspect of the present invention, a computer-implemented method for analyzing collaborative competitive pursuit and creating of enterprise value is provided, comprising: identifying, using a processor, a customer's vision, mission, and evaluation factors; collecting data on individuals and an enterprise; assessing psychographically, using the processor, customer role relationship status of the individuals and the enterprises to identify one or more of an advocate, a team member, agnostic, an adversary, a participant, an influencer, and a decision maker; assessing, using the processor, an enterprise's competitiveness by analyzing strengths, weaknesses, opportunities, and threats for the enterprise as well as competitors, bidder comparisons, Porter's Five Forces analysis, and Black Hat review and analyzing a potential customer's bid issues and decision factors; identifying, using the processor, discriminators and competitiveness gaps; developing a win strategy using the processor; generating automatically analysis-based lists of proposal strategies using the processor; identifying, using the processor, partners, a leadership team, a staffing solution, and resources; developing a pricing strategy using the processor; generating automatically, using the processor, analysis-based lists of strengths; and preparing value statements from a structured template using the processor; and producing a report including a temporal graphical depiction of analytical results.

These and other features, aspects and advantages of the present invention will become better understood with reference to the following drawings, description, and claims.

### BRIEF DESCRIPTION OF THE DRAWINGS

FIG. 1 is a schematic diagram of a system according to an embodiment of the present invention;

FIG. 2 is a block diagram of framework phases according to an embodiment of the present invention;

FIG. 3 is a block diagram of modules within an opportunity assessment phase thereof;

FIG. 4 is a block diagram of modules within a capture phase thereof;

FIG. 5 is a block diagram of modules within a proposal planning phase thereof;

FIG. 6A is a block diagram aggregating the block diagrams of FIGS. 3 and 4;

FIG. 6B is a block diagram aggregating the block diagrams of FIGS. 4 and 5; and

FIG. 7 is a block diagram of indices produced by the modules of FIGS. 6A and 6B.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

As used herein, the term “federate” refers to integrating data from a heterogeneous set of autonomous databases. “SWOT analysis” refers to an analysis of strengths, weaknesses, opportunities, and threats. A “strength” refers to something that an enterprise or competitor inherently does well or a capability which enables the success of contract award and performance, the customer's mission and/or business, and/or some other element that the customer considers a benefit. A “weakness” refers to something that an enterprise or competitor does not do well or a capability or benefit that is lacking, increasing the risk of unsuccessful contract award and performance and/or adverse impact to the customer's mission and/or business. The term “opportunity” as used herein means a future action that may enable an enterprise's or competitor's success of contract award and performance, that may enhance the customer's mission and/or business, that a customer may consider a benefit, and/or that may increase the likelihood of winning a competitive pursuit. The term “threat” as used herein means something that if not addressed may increase an enterprise's or competitor's risk of unsuccessful contract award and performance and/or adverse impact to the customer's mission and/or business, and/or that may decrease the likelihood of winning a competitive pursuit. The phrase “design considerations” (DC) refers to an enterprise's internal challenges, conditions, and constraints. The term “discriminator” as used herein refers to a feature that enables an enterprise to stand out from its competitors. A discriminator is preferably unique (i.e., no other offeror can make the same claim), preferably provides a self-evident benefit to stakeholders, and is preferably important to key decision makers and influencers.

Broadly, one embodiment of the present invention is a collaborative, analytical pursuit tool for competitive bids, the output of which feeds solution development and enterprise value creation. It is a capture-as-a-service capability that is provided as a software-as-a-service, resident on an enterprise's own internal enterprise network, or accessible via the enterprise's own private cloud. Each aforementioned provision of the tool is preferably accessible via a mobile device. The tool may identify all the components that make up a winning proposal response, including but not limited to issue and key factor (IKF) analysis, notional winner benchmark, competitive assessment, discriminator qualification, win strategy and proposal strategy formulation, and solution development. The inventive tool allows for permission-based access to collaborative competitive pursuit analysis activities and their resulting outputs (e.g., proposal strategies) based upon assigned role (e.g., technical contributor, pricing analyst). In addition, it provides the ability to automatically tailor headings depending on whether the pursuit is business-to-government or business-to-business.

SET mitigates the risk associated with disruptions and interruptions that often occur in competitive pursuits by maintaining a traceable, irrefutable, defensible, and explainable digital thread of all pursuit activities and enterprise-wide (e.g., company), competitor, and customer context gathered to date. As such, SET acts as the authoritative source-of-truth for the pursuit and provides continuity through all disruptions and interruptions to the pursuit.

SET may serve as an authoritative source-of-truth for gate and color teams and reduces uncertainty, which often challenges executive-level decision-making. Color team/gate reviews may include a Purple Team to assess P-Win and alignment with enterprise-wide goals; a Light Blue Team to review an initial capture strategy and capture plan; a Black Hat Team to predict competitor solutions; a Dark Blue team to review an updated capture plan and Integrated Solution Set; a Pink Team to review storyboards, mockups, and specification sheets; a Green Team to review costs and price-setting; a Red Team to review the final proposal draft; a Gold Team to approve the final proposal and price; and a White Team to compile lessons learned from the process.

The inventive tool may provide modules consistent with recursive activities within and across three phases identified in the Solution Engineering Framework™ including an opportunity assessment phase, a capture phase, and a proposal planning phase. The opportunity assessment phase may include identification of a potential customer's “hot button” issues and key factors (IKFs). IKFs determine the basis for the customer's issues (i.e., what is driving them) and the technical, management, personnel, and corporate experience key factors which any competitor pursuing the opportunity must deliver to address the customer's issues and why the respective key factors are important to the customer. A notional winner benchmark and design considerations feed into the capture phase. The capture phase may include a competitive assessment, identification of discriminators, and identification of gaps that may affect development of a win strategy, including win themes and win tactics, used to develop proposal strategies. The proposal planning phase may include identification of partners, a leadership team, a staffing solution, and suitable framework, methods, processes, facilities, tools, certifications, and techniques; evaluation of past performance; and development of a technical approach, a management approach, and a pricing strategy, which may include price-to-win and basis-of-estimate analyses. These features may be compared to evaluation criteria and may be used to identify strengths (i.e., customer benefits and mitigated risks), and value statements, all of which may provide evidence for why the customer should select the user's bid.

In some embodiments, data may be imported to prepopulate various modules. Each module may have a table and/or matrix populated by relevant data, displayed in a view, and saved in one or more files, and may provide embedded training available in text, audio-only, and video formats.

SET enables a pursuit team to document and assess customer role relationship status using psychographics, setting the business development teams and corporate services up for success. The system may collect and track data on a wide variety of individuals and enterprises, identifying each as an advocate, a team member, agnostic, an adversary, a participant, an influencer, and/or a decision maker.

The inventive tool may identify a customer's “hot button” issues using a customer overview (including the customer's vision and mission), a customer “SWOT” analysis (including strengths and weaknesses), and the customer's evaluation factors.

In some embodiments, an evaluation criteria module includes information about hot button issues and key factors, including technical (KTF), management (KMF), personnel (KPF), and corporate experience (KCEF) factors. The evaluation factors may be weighted such that they sum to 1.00.

The present invention may include a competitive assessment including SWOT analysis for the user's enterprise as well as any competitors, bidder comparisons, Porter's Five Forces analysis, and Black Hat review. Porter's Five Forces Analysis considers the threat of new entrants and substitute services, the bargaining power of buyers, suppliers and/or subcontractors, and incumbents' rivalry.

The inventive tool may provide automated workflows and automatic generation of analysis-based lists of proposal strategies and strengths which proposal evaluators may use to support an award decision.

The user may easily perform analyses with the inventive tool to provide real benefit and risk mitigation to the customer across all components of an integrated solution.

The inventive system is also advantageous because it builds a data lake of enterprise-derived (e.g., company) competitive business intelligence and captures the intellectual capital of subject matter experts to decisively increase the success of the next pursuit and the overall value of the enterprise. SET may quantify emerging data for thousands of opportunities, enabling data mining to build equity that is otherwise lost.

According to some embodiments of the present invention, the analytical tool prompts a subject matter expert (also referred to as “talent”) to answer questions which are used to prepare a specification sheet. The specification sheet enables for efficient and effective review of subject matter expert input to the proposal response activity. Every time a subject matter expert, traditionally responsible for writing proposal response content, prepares specification sheets, SET may capture the intellectual capital which becomes the enterprise's intellectual property, contributing to the SET data lake. As a result, every time SET is used for a competitive pursuit, the value of the enterprise increases.

In some embodiments, the SET method further comprises query-based Artificial Intelligence (AI)/Machine Learning (ML) that may pull competitive intelligence, intellectual capital, or proprietary information from a data lake specific to only the enterprise on which customer and competitive intelligence, strategies, actions, or solutions to consider for a specific competitive pursuit, or which strategies, actions, or solutions have led to competitive wins or losses. The tool allows numerous distinct Al/ML-based types of queries.

In some embodiments, a staffing solution module may include background information about individuals being proposed for the opportunity. The background information may be aggregated in a matrix and analyzed to extract quantifiable strengths supportive of the pursuit's bid.

In some embodiments, a strengths' module aggregates strengths that benefit a customer and/or mitigate risk. Evaluation factors may be weighted such that they sum to 1.00.

Phase review data may be used to produce anchor graphics and captions, value statements, Freytag's Pyramid-based stories, specification sheets, and preparation status. A module of the present invention may automatically email a link and embedded form to individuals assigned to develop each intermediate product and may track the status of all assignments. The form may collect data for use in writing a compliant, convincing, and compelling narrative. An automatic notification may be sent when completion exceeds a threshold, such as 50%. Value statements may be prepared from a structured template used to gather information important to the customer and supporting data showing benefit to the customer. In addition, there is the ability to outline and automatically generate customer-focused stories using Freytag's Pyramid, which is paradigm of dramatic structure outlining seven key steps in successful storytelling: exposition, inciting incident, rising action, climax, falling action, resolution, and denouement.

Each module of the inventive tool may produce a report, periodically or on-demand. Data from each module may be presented in graphs or plots over time and may be exportable to another application, such as Microsoft® Word™.

SET enables simple quantification of the quality and effectiveness of business development efforts. This includes the hand-off from business development to capture management; the hand-off from capture management to proposal development; and recompete readiness for existing contracts, something which is important to investors. The inventive system provides five algorithmic-based quantitative indices which collectively measure the quality of performance throughout the business development lifecycle; overall growth status of the enterprise; as well as the overall value of the enterprise when factoring in the status of its growth and the value of its intellectual capital based upon customer evaluator feedback.

Indices according to the present invention may be calculated, for example, as a root mean square value.

The Opportunity Context Index (OCI) measures readiness to use SET to enable an enterprise's Probability of Winning (P-Win) an opportunity. OCI is an aggregated calculation of scores, on a scale of 0 to 1, of about 40 individually rated factors from the Solution Engineering Framework™, based upon understanding of one's enterprise, customer, and the competition, context that is believed essential to optimally using SET. OCI may measure the quality of the hand-off from business development to capture management. The OCI score may be one element of an enterprise's consideration to pursue an opportunity, as well as its P-Win calculation.

The inventive tool may calculate a Pursuit Index (PI) aggregating about 26 individually rated components of the Solution Engineering Framework™, each on a scale of 0 to 1. The PI may be used to evaluate whether the right things are being done as they relate to SET to help win the pursuit, and if yes, how well they are being they done. The PI value enables but is not the same as Probability-of-Winning (P-Win).

The inventive tool may calculate a Recompete Readiness Index (RRI) based on responses to about 20 individually rated questions from the Solution Engineering Framework™, each assigned a value on a scale of 0 to 1. RRI gauges how well an incumbent enterprise is prepared to win a recompete for a customer contract. RRI may be used to reinitiate capture management activities to win the current contract again. It is generally recommended that readiness for recompete be assessed periodically (for example annually), preferably beginning no later than halfway through the life of the current contract.

The inventive tool may calculate a Growth Status Index (GSI), aggregating the values from the Opportunity Context Index (OCI); the Pursuit Index (PI); and the Recompete Readiness Index (RRI) to help answer the question “What is the current growth status of a company?” as compared to market value.

The inventive tool may calculate a Korporate Equity Index (KEI), which measures the overall value of the enterprise when looking at its ability to win future competitive bids as reflected by the enterprise's Growth Status Index (GSI) and the goodness of the enterprise's intellectual capital in the view of customer evaluators as part of the enterprise's past competitive bids whether the enterprise won or lost the opportunity. As used herein, the “K” in the term “Korporate” emphasizes the application of knowledge in determining an enterprise's success. Goodness factors include customer evaluator-provided past performance; personnel; technical; and management ratings for the enterprise's competitive bids, each of which is assigned a value of 0 to 1. The enterprise takes these ratings and uses the inventive tool to align them with the tool's own internal quantitative ratings for them, as well as uses the GSI value to calculate the enterprise's KEI. These ratings may be provided as running historical averages on a scale of zero (unacceptable) to 1 (excellent). The KEI value falls within one of three ranges (i.e., 0.75 to 1; 0.5 to 0.74; and 0 to 0.49), which may be used to support determining an enterprise's value as compared to the enterprise's market value.

In some embodiments, each index (i.e., OCI, PI, RRI) may have an indicator allowing selection of a color to indicate adequacy with respect to evidence, understanding of a factor, and/or readiness. For example, green may be used to indicate “more than adequate”; yellow may be used to indicate “adequate”, and red may be used to indicate “inadequate” or “less than adequate”.

In some embodiments, each index (i.e., OCI, PI, RRI) may have a score to indicate adequacy with respect to evidence, understanding of a factor, and/or readiness. For example, a score in the range of 0.75 to 1.0 may indicate “More Than Adequate”, a score in the range of 0.5 to 0.74 may indicate “Adequate”, and a score in the range of 0 to 0.49 may indicate “Inadequate”.

The inventive tool may calculate a likely and actual cost-of-capture (COC) of a competitive pursuit for an enterprise. The cost-of-capture analysis helps make well-informed decisions about an enterprise's business operations and allocations of business resources. Moreover, the analysis may support root-cause analysis around cost variances, revealing true drivers of higher than projected bid and proposal (B&P) costs, and may enable maintenance of future cost control. Costs of capture may occur during any of the following phases: market assessment, opportunity assessment; capture; proposal planning; proposal preparation and post-submittal; and award and delivery. The costs are generally cumulative over time. The cost-of-capture may include any combination of costs selected from the group consisting of: client access; shape and influence; plan and prepare; off-ramp; deferral; restart; recovery; and loss of opportunity. The costs may include monetary costs as well as loss of credibility, image, or prestige. Predictive analysis of expected costs and unexpected costs may identify a likelihood of each cost as a percentage, which is preferably minimized.

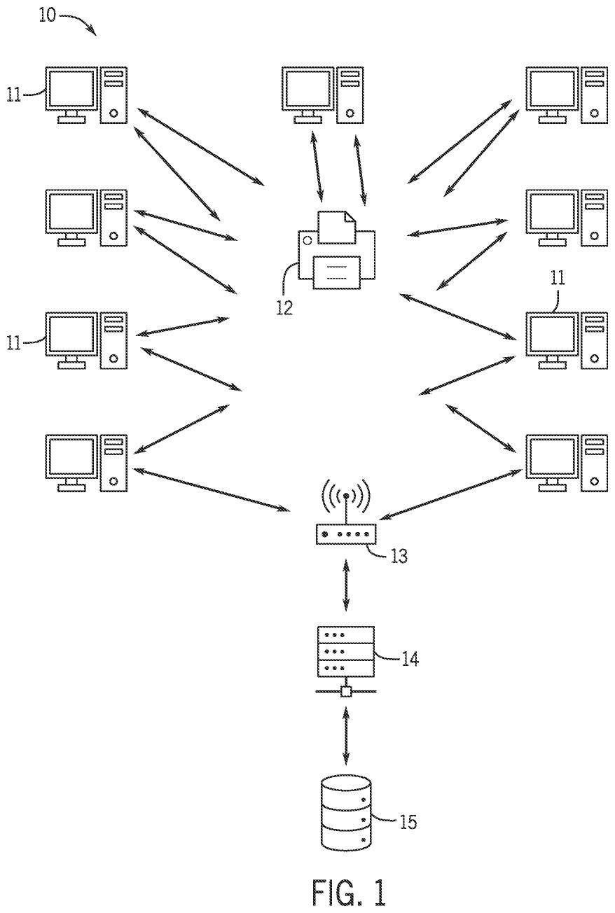

Referring to FIGS. 1, 2, 3, 4, 5, 6A, 6B, and 7, a method and a tool or system therefor according to an embodiment of the present invention is shown.

FIG. 1 shows a system 10 according to an embodiment of the present invention. A server 14 operating the collaborative, analytical pursuit tool stores data on a database on a memory storage device 15 and sends and receives data over a network or the internet 13. The server 14 is accessed by users 11 from a pursuit team, a business development team, a solution developer, a proposal development manager, technical staff, a capture management team, color teams, corporate services, and subject matter experts. Each user 11 contributes data and analysis to the system and produces reports via a printer 12.

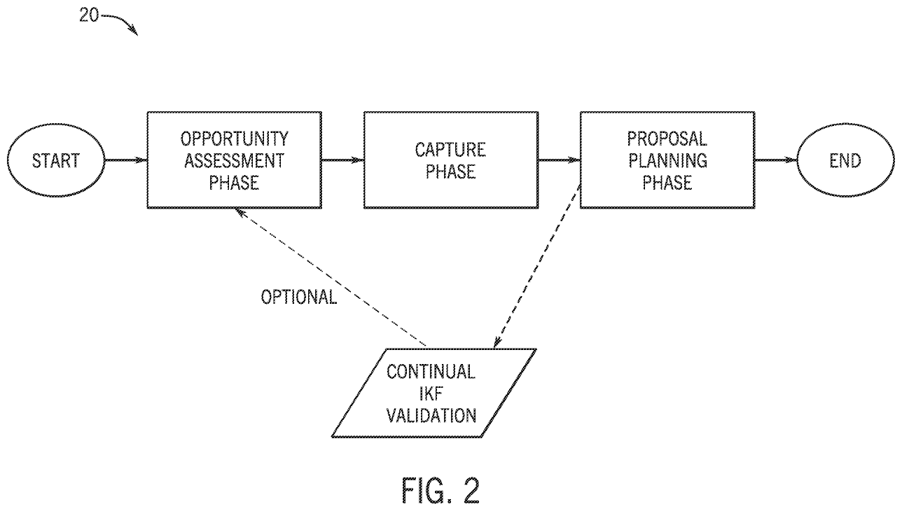

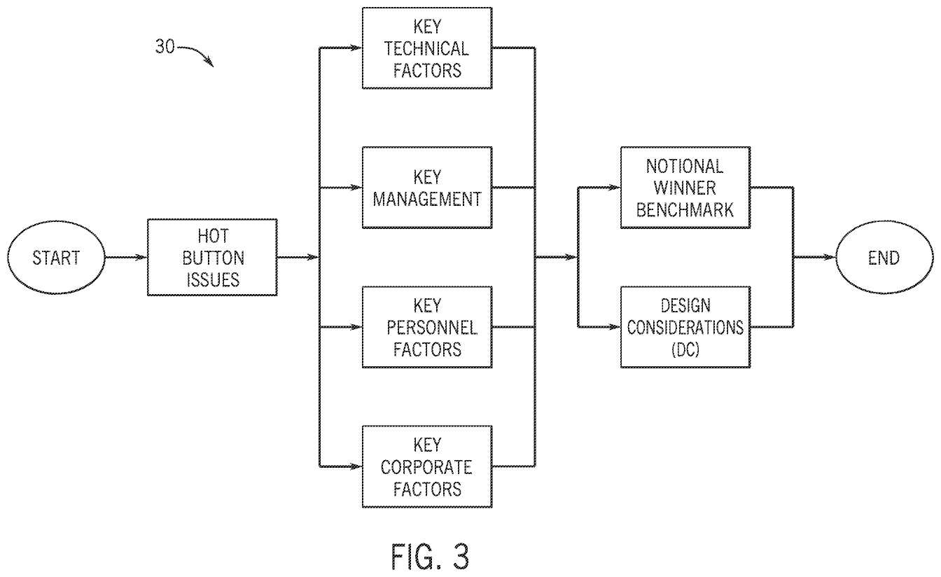

FIG. 2 shows the three main phases forming a framework 20 for the method. In the Opportunity Assessment phase 30 shown in FIG. 3, the user may perform a thorough analysis of the customer's issues 1.1 to truly understand why the customer put out a competitive bid to address its issues. With SET, a pursuit team may document and assess customer role relationship status using psychographics. Likewise, the tool may be used to identify key factors 1.2, 1.3, 1.4, 1.5 that a competitor seeking to address the customer's issues may provide and why those key factors are important to the customer. SET may be used to establish a notional winner benchmark 1.6 (NWB) of the ideal enterprise to win the pursuit.

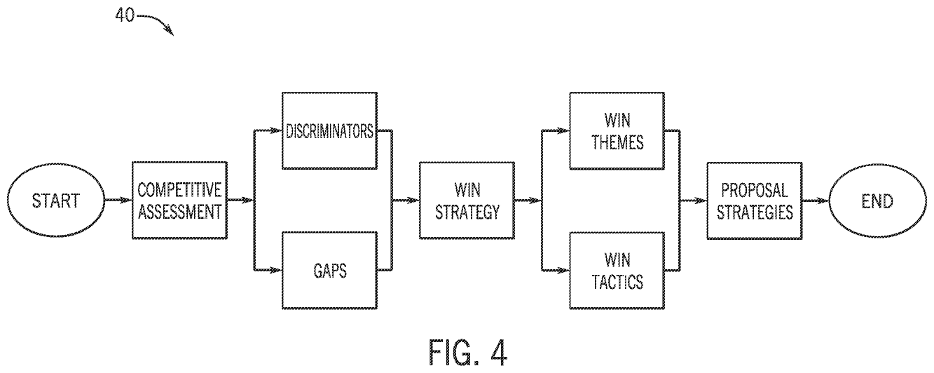

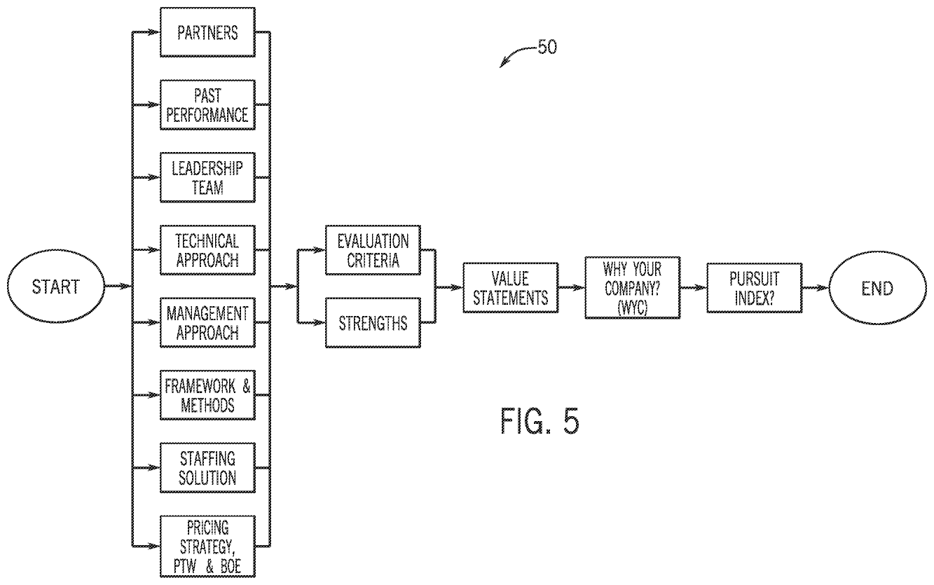

FIG. 4 illustrates the Capture phase 40, in which the team may use various methods with SET to perform a competitive assessment 2.1. SET may be used to qualify an enterprise's discriminators 2.2 and really understand the greatest competitive gaps 2.3. SET may be used to produce a win strategy 2.4 and win themes 2.5 that are easily traceable, irrefutable, defensible, and explainable to the enterprise's executive decision-makers. SET may automatically build a listing of proposal strategies 2.7 based upon a competitive analysis so that the user knows when and where to apply them to influence the customer and develop the components of an integrated solution in the Proposal Planning phase 50, shown in FIG. 5. The integrated solution may include teaming partner(s) 3.1, past performance 3.2, and leadership team 3.3 (that is, key personnel) selections. The solution may also include formulating a technical approach 3.4 and management approach 3.5 and selecting the frameworks, methods, processes, tools, and techniques 3.6 that enable them. The user may build a staffing solution 3.7 that easily aligns with the technical and management approaches 3.4, 3.5 and helps justify the basis-of-estimate (BOE) for a price (Price-to-Win [PTW]) 3.8. SET may automatically build a listing of strengths 3.10 based upon a business pursuit team's competitive analysis and the development of the integrated solution. The identified strengths 3.10 may be allocated against the scope of work in advance of any proposal writing to verify that the enterprise has sufficient strengths to maximize scored points against the customer's evaluation criteria 3.9. The user may build convincing and compelling customer value statements 3.11 with all the elements on hand from SET's analyses. SET may automatically visually federate all the analyses that have been performed to help answer the most important question in a competitive pursuit, “Why Your Enterprise?” 3.12.

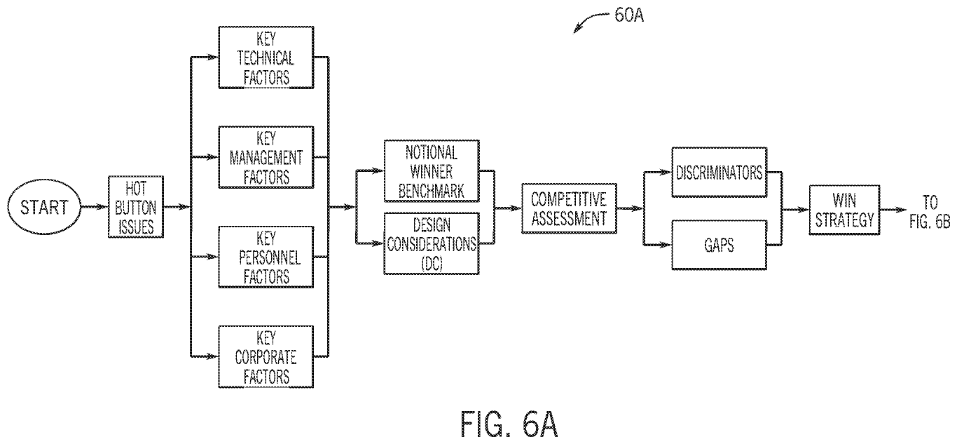

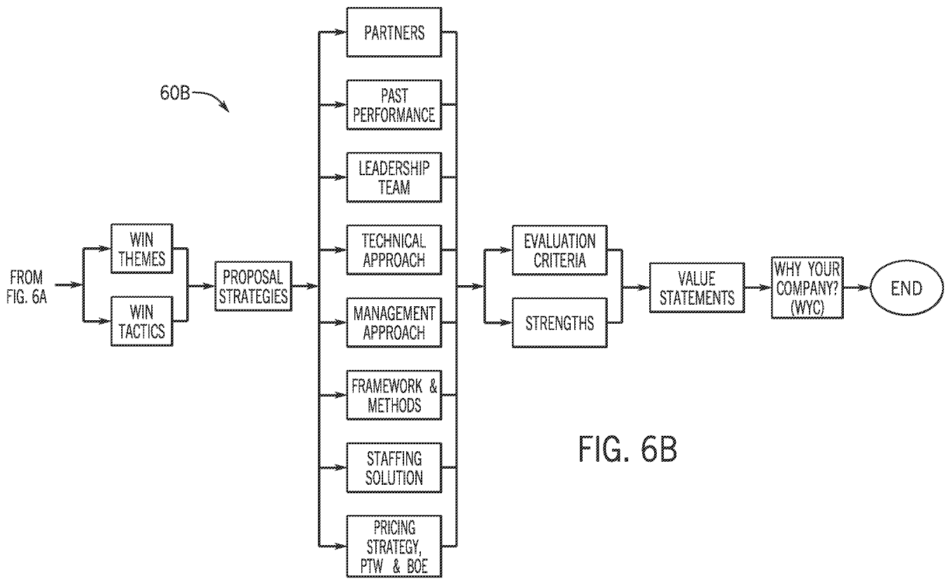

The overall process 60A, 60B shown in FIG. 6A and 6B may provide a digital thread to address the customer's issues and key factors which are the drivers of the customer's procurement. A Pursuit Index (PI) SI.2 may be calculated to measure the quality of the hand-off from capture management to proposal development.

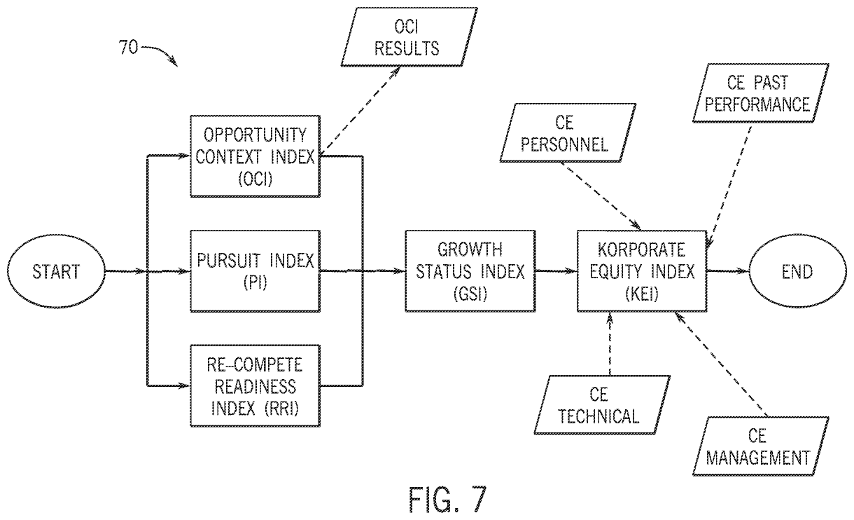

As illustrated in FIG. 7, the inventive tool may calculate a series of indices 70 including a Growth Status Index (GSI) SI.4 aggregated from at least one of an Opportunity Context Index (OCI) SI.1, the Pursuit Index (PI) SI.2, and a Re-Compete Readiness Index (RRI) SI.3. The inventive tool may calculate a Korporate Equity Index (KEI) SI.5 aggregated from Growth Status Index (GSI) SI.4 and individually calculated values for the goodness of the enterprise's intellectual capital in the view of customer evaluators as part of the enterprise's past competitive bids whether the enterprise won or lost the opportunity. Goodness factors in customer evaluator-provided past performance; personnel; technical; and management ratings for the enterprise's competitive bids. The enterprise takes these ratings and uses the inventive tool to align them with the tool's own internal quantitative ratings for them to help determine KEI.

It should be understood, of course, that the foregoing relates to exemplary embodiments of the invention and that modifications may be made without departing from the spirit and scope of the invention as set forth in the following claims.

What is claimed is:

1. A collaborative analytical pursuit system for competitive bids comprising:
a data repository, embodied in a computer-readable storage medium, configured to store a data lake comprising competitive intelligence data, intellectual capital data, and proprietary data; and
a server comprising a memory and a processor, the processor of the server configured to:
collect and assess data indicating issues and decision factors associated with a bid in an opportunity assessment module;
collect and assess data indicating competitiveness, identifying discriminators, and identifying gaps in bid win themes and bid win tactics in a capture module;
identify at least one of: partners, a leadership team, a staffing solution, facilities, tools, certifications, and techniques; and develop a bid technical approach, a bid management approach, and a bid pricing strategy in a proposal planning module;
calculate a numerical value associated with data from at least one of the opportunity assessment module; the capture module; and the proposal planning module;
store the data and the numerical value in the data repository; and
produce a report including a temporal graphical depiction of the numerical value.

2. The collaborative analytical pursuit system of claim 1, wherein the numerical value is a Pursuit Index determined by averaging pursuit criteria.

3. The collaborative analytical pursuit system of claim 1, wherein the numerical value is a Recompete Readiness Index, determined by averaging recompete readiness criteria.

4. The collaborative analytical pursuit system of claim 1, wherein the report color-codes the numerical value to indicate one or more of evidence adequacy, understanding adequacy, and readiness adequacy.

5. The collaborative analytical pursuit system of claim 1, further comprising an evaluation criteria module operative to rate technical factors, management factors, personnel factors, and corporate experience to produce ratings, and to weight the ratings such that they sum to 1.00.

6. The collaborative analytical pursuit system of claim 1, further comprising a staffing solution module operative to collect and analyze individual staff background information relative to a bid proposal.

7. The collaborative analytical pursuit system of claim 1, further comprising a strengths' module operative to rate enterprise strengths relative to customer benefit and risk mitigation to produce ratings, and to weight the ratings such that they sum to 1.00.

8. The collaborative analytical pursuit system of claim 1, further comprising query-based Artificial Intelligence and/or Machine Learning operative to extract data from the data lake to determine one or more of a customer, a competitive intelligence, a bid strategy, a bid action, and a bid solution.

9. The collaborative analytical pursuit system of claim 1, wherein the numerical value is an Opportunity Context Index, calculated by aggregating individual rating values of enterprise factors selected from the group consisting of technical, management, personnel, and corporate; and individual customer factor rating values.

10. The collaborative analytical pursuit system of claim 9, further comprising calculating a Growth Status Index by aggregating the Opportunity Context Index; a Pursuit Index; and a Recompete Readiness Index.

11. The collaborative analytical pursuit system of claim 10, further comprising calculating a Korporate Equity Index between 0 and 1 based on an assessment of personnel performance ratings; technical performance ratings; and management performance ratings.

12. A computer-implemented method for analyzing collaborative competitive pursuit and creating of enterprise value, comprising:
identifying, using a processor, a customer's vision, mission, and evaluation factors;
collecting data on individuals and an enterprise;
assessing psychographically, using the processor, customer role relationship status of the individuals and the enterprises to identify one or more of an advocate, a team member, agnostic, an adversary, a participant, an influencer, and a decision maker;
assessing, using the processor, an enterprise's competitiveness by analyzing strengths, weaknesses, opportunities, and threats for the enterprise as well as competitors, bidder comparisons, Porter's Five Forces analysis, and Black Hat review and analyzing a potential customer's bid issues and decision factors;
identifying, using the processor, discriminators and competitiveness gaps;
developing a win strategy using the processor;
generating automatically analysis-based lists of proposal strategies using the processor;
identifying, using the processor, partners, a leadership team, a staffing solution, and resources;
developing a pricing strategy using the processor;
generating automatically, using the processor, analysis-based lists of strengths; and
preparing value statements from a structured template using the processor; and
producing a report including a temporal graphical depiction of analytical results.

13. The computer-implemented method of claim 12, further comprising:
measuring business development lifecycle performance quality;
determining enterprise growth status with the processor;
calculating a cost of capturing business with the processor; and
calculating an overall enterprise value index with the processor.

14. The computer-implemented method of claim 12, further comprising:
parsing access, using the processor, to collaborative competitive pursuit analysis activities and proposal strategies based upon identified role.

15. The computer-implemented method of claim 12, further comprising:
tailoring document headings automatically using the processor based on a target customer;
producing anchor graphics, captions, value statements, and an outline using the processor; and
generating automatically customer-focused dramatic structured stories and bid preparation status using the processor.

16. The computer-implemented method of claim 12, further comprising:
prompting a subject matter expert to answer questions; and
preparing a specification sheet automatically with the processor.

17. The computer-implemented method of claim 12, further comprising:
calculating a predicted cost-of-capture and an actual cost-of-capture of a competitive pursuit including any combination of costs selected from the group consisting of: client access; shape and influence; plan and prepare; off-ramp; deferral; restart; recovery; and loss of opportunity.

18. The computer-implemented method of claim 12, further comprising:
preparing automatically using the processor and sending an email with a link to an embedded form to an individual assigned to develop an intermediate product;
collecting input for writing a bid narrative using the embedded form using the processor; and
tracking a status of an assignment using the processor.

19. The computer-implemented method of claim 12, further comprising:
collecting and analyzing input from team members using the processor and storing documents to a data repository.

20. The computer-implemented method of claim 19, further comprising:
maintaining, using the data repository, a traceable, irrefutable, defensible, and explainable digital thread of pursuit activities and enterprise-wide, competitor, and customer context; and
building a data lake of enterprise-derived competitive business intelligence.
